(19) United States
(12) Patent Application Publication
(10) Pub. No.: US 2025/0047192 A1
(43) Pub. Date: Feb. 6, 2025

(54) INRUSH CURRENT LIMITING CIRCUIT FOR POWER SYSTEM

(71) Applicant: FADU Inc., Seoul (KR)

(72) Inventors: Seonho KIM, Suwon-si (KR); Jungeui PARK, Suwon-si (KR); Jaeil LEE, Gwangmyeong-si (KR); Jongchul CHAE, Hwaseong-si (KR)

(73) Assignee: FADU Inc., Seoul (KR)

(21) Appl. No.: 18/793,362

(22) Filed: Aug. 2, 2024

(30) Foreign Application Priority Data
Aug. 2, 2023 (KR) 10-2023-0100885

(51) Int. Cl. H02M 1/32; H02H 9/02; H02M 1/36; H02M 3/158

(52) U.S. Cl. CPC H02M 1/32; H02H 9/02; H02M 1/36; H02M 3/158

(57) ABSTRACT

Discloses is an inrush current limiting circuit for a power system. In the power system that charges an output capacitor when an input voltage is initially applied and in which multiple resistance elements and switching elements are connected in an electrical path that connects the input voltage and an output voltage, the inrush current limiting circuit for the power system implements the soft start of the power system by limiting a peak value of an input current to a predetermined level or less by changing a total resistance value of the electrical path through an operation of the switching elements.

### TECHNICAL FIELD

The present disclosure relates to an inrush current limiting circuit for a power system, and more particularly, to an inrush current limiting circuit that limits the peak value of a current that instantly flows by using a passive element during the soft start period of a power system.

### BACKGROUND ART

A power system is used to supply power to an electronic device and an electronic load. The power system may be a DC/DC converter, for example. The DC/DC converter is divided into a boost converter that boosts a DC input voltage and a buck converter that drops a DC input voltage.

Referring to FIGS. 1 and 2, in a boost converter, two power switches SW1 and SW2 are connected between an output stage and a ground stage. An inductor is connected to an input stage that is electrically connected to a node at which the power switches are connected. An output capacitor is connected to the output stage. Each of the power switches is implemented with a diode and a transistor. In this case, when an input voltage V_{IN} is applied and the level of an enable (EN) terminal is a high level, as the two power switches alternately repeatedly perform on/off operations based on their duty ratio, an output voltage VOUT higher than the input voltage V_{IN} is output.

A problem arises in a case in which the input voltage is applied when the level of the enable (EN) terminal is a low level, that is, at the early stage, that is, in the state in which the two power switches are turned off. In this case, as illustrated in FIG. 1, a current path is formed along the input voltage V_{IN}, the inductor, the diode D2 of the power switch SW2, and the output voltage VOUT. Accordingly, an input voltage supply device and a chip may be damaged because a very high charging current is generated.

Accordingly, there is an urgent need for a scheme for solving a problem in that an excessive current flows when power is initially supplied in a conventional power system.

### DETAILED DESCRIPTION OF THE INVENTION

### Problems to be Solved by the Invention

Various embodiments are directed to providing an inrush current limiting circuit for a power system that implements a soft start by limiting a peak value of an input current to a predetermined level or less by changing a total resistance value of an electrical path that connects an input voltage and an output voltage through an operation of switching elements, in the power system in which multiple resistance elements and switching elements are connected in the electrical path and that charges an output capacitor when the input voltage is initially applied.

### Means for Solving the Problems

In an embodiment, an inrush current limiting circuit for a power system, which implements a soft start of the power system that outputs an output voltage by charging an output capacitor when an input voltage is applied includes a resistance array including a resistance string including N resistance elements that are connected in series from a first resistance element on one outermost side thereof an N-th resistance element (N is a natural number equal to or greater than 2) on the other outermost side thereof, wherein the first resistance element is connected to a first node in an electrical path that connects the input voltage and the output voltage, and the N-th resistance element is connected to a second node in the electrical path, and a resistance change unit including first to N-th bypass paths that connect intermediate nodes that are branched from the first node and to which resistance elements that are adjacent to each other, among the N resistance elements, are connected and the second node and first to N-th switching elements that are connected to the first to N-th bypass paths in a one-to-one way. A total resistance value of the electrical path is changed by on/off operations of the first to N-th switching elements.

Furthermore, in the inrush current limiting circuit for the power system according to an embodiment of the present disclosure, the power system may include a boost converter circuit or a power loss protection (PLP) circuit.

Furthermore, in the inrush current limiting circuit for the power system according to an embodiment of the present disclosure, the N resistance elements may have an identical resistance value or any one or more of the N resistance elements may have different resistance values.

Furthermore, in the inrush current limiting circuit for the power system according to an embodiment of the present disclosure, the resistance array may further include N affiliated resistance elements that are connected to the first to N-th bypass paths in a one-to-one way.

Furthermore, the inrush current limiting circuit for the power system according to an embodiment of the present disclosure may further include a switching control unit configured to detect a voltage value of the output voltage and to control the on/off operations of the first to N-th switching elements based on the detected voltage value of the output voltage.

Furthermore, in the inrush current limiting circuit for the power system according to an embodiment of the present disclosure, the switching control unit may compare a preset reference voltage and the voltage value of the output voltage, and may control the on/off operations of the first to N-th switching elements so that a total resistance value of the electrical path after the comparison becomes smaller than a total resistance value of the electrical path before the comparison when the voltage value of the output voltage is higher than the reference voltage.

Furthermore, in the inrush current limiting circuit for the power system according to an embodiment of the present disclosure, the switching control unit may include K (K is a natural number of N+1) reference resistance elements that are connected in series between a third node in the electrical path and a ground, and N comparators connected to N reference nodes to which reference resistance elements that are adjacent to each other, among the K reference resistance elements, are connected in a one-to-one way and matched with the first to N-th switching elements in a one-to-one way. Each of the N comparators may compare a voltage of the reference node applied thereto, as the reference voltage, with the voltage value of the output voltage, and may output a control signal so that the on operation of one of the first to N-th switching elements that are matched is performed when the voltage value of the output voltage is higher than the reference voltage.

Furthermore, in the inrush current limiting circuit for the power system according to an embodiment of the present disclosure, the N reference resistance elements may have an identical resistance value or any one or more of the N reference resistance elements may have different resistance values.

Characteristics and advantages of the present disclosure will become more evident from the following detailed description with reference to the accompanying drawings.

Prior to the detailed description, terms or words used in the specification and the claims should not be construed as having common or dictionary meanings, but should be construed as having meanings and concepts that comply with the technical spirit of the present disclosure based on the principle that the inventor may appropriately define the concepts of the terms in order to describe his or her disclosure in the best manner.

### Effects of the Invention

According to embodiments of the present disclosure, a peak current can be simply reduced and the soft start of a power system can be simply implemented by changing a total resistance value of the power system in an electrical path that connects an input voltage and an output voltage by using the multiple resistance elements and the switching element, regardless of the slew rate of the input voltage.

Furthermore, the inrush current limiting circuit according to an embodiment of the present disclosure may be applied to various power systems that store energy in an output capacitor, like a power loss protection (PLP) circuit.

Moreover, an influence attributable to an abnormal operation of an analogue block and power consumption can be minimized through a minimization design for the analogue block.

### BRIEF DESCRIPTION OF THE DRAWINGS

FIG. 1 is a diagram describing a structure and operation of a conventional boost converter.

FIG. 2 is a graph illustrating a change of an output voltage and input current of the conventional boost converter over time.

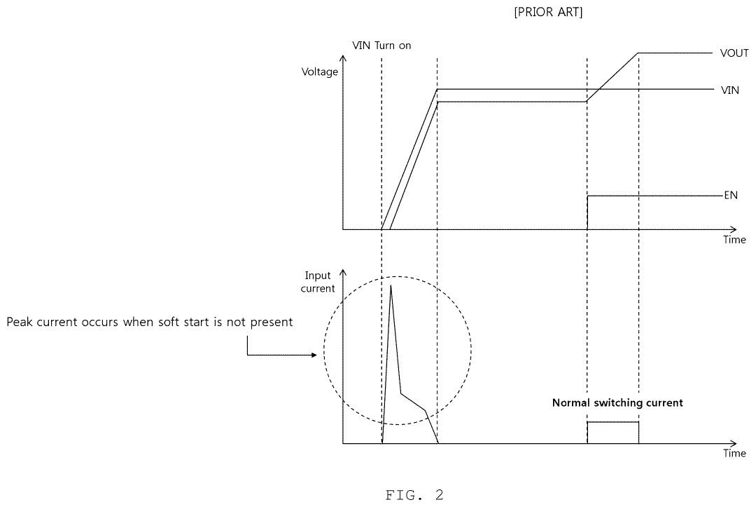

FIG. 3 is a circuit diagram illustrating an inrush current limiting circuit for a power system according to an embodiment of the present disclosure.

FIGS. 4 and 5 are circuit diagrams illustrating examples in which the inrush current limiting circuit for the power system according to an embodiment of the present disclosure is applied to a boost converter.

FIGS. 6 to 9 are circuit diagrams describing a process of the inrush current limiting circuit for the power system according to an embodiment of the present disclosure operating by being applied to the boost converter, as illustrated in FIG. 4.

FIG. 10 is a circuit diagram illustrating an inrush current limiting circuit for a power system according to another embodiment of the present disclosure.

FIG. 11 is a circuit diagram illustrating an embodiment of a switching control unit illustrated in FIG. 10.

FIG. 12 is a circuit diagram describing a process of the inrush current limiting circuit for the power system according to another embodiment of the present disclosure operating by being applied to the boost converter.

FIG. 13 is a graph illustrating a change in the output voltage and input current of the boost converter during each period in which the switching elements illustrated in FIG. 12 sequentially operate.

FIG. 14 is a circuit diagram illustrating an inrush current limiting circuit for a power system according to still another embodiment of the present disclosure.

FIG. 15 is a graph illustrating a change in the input current of a boost converter during each period in which the switching element illustrated in FIG. 14 operates.

### BEST MODE FOR CARRYING OUT THE INVENTION

Objects, specific merits and novel characteristics of the present disclosure will become more apparent from the following detailed description and exemplary embodiments taken in conjunction with the accompanying drawings. In adding reference numerals to the components of each drawing in the specification, it should be noted that the same components have the same reference numerals as much as possible even if they are displayed in different drawings. Furthermore, terms, such as a “first” and a “second”, are used to distinguish one component from the other component, and a component is not restricted by the terms. Hereinafter, in describing the present disclosure, the detailed description of a related well-known technology which may unnecessarily obscure the subject matter of the present disclosure will be omitted.

Hereinafter, embodiments of the present disclosure are described in detail with reference to the accompanying drawings.

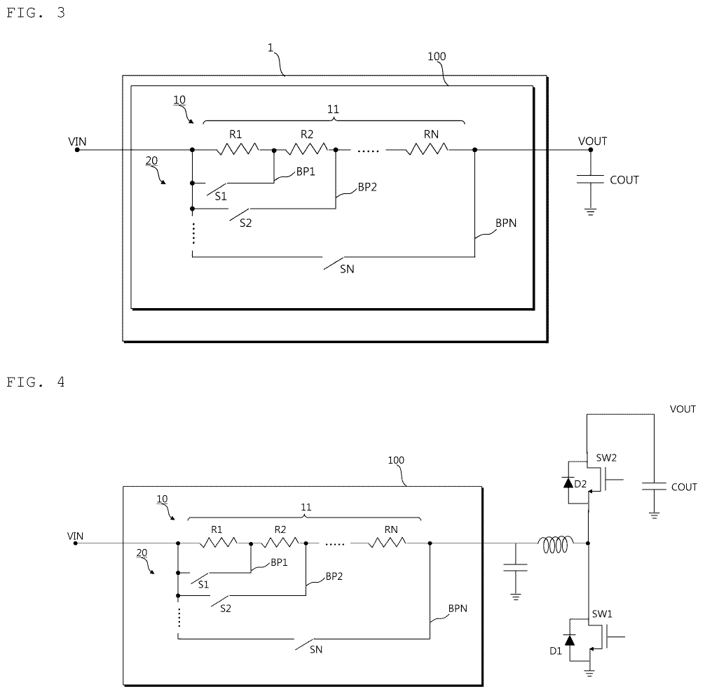

FIG. 3 is a circuit diagram illustrating an inrush current limiting circuit for a power system according to an embodiment of the present disclosure.

As illustrated in FIG. 3, an inrush current limiting circuit 100 for a power system according to an embodiment of the present disclosure, which implements the soft start of a power system 1 that outputs an output voltage VOUT by charging an output capacitor COUT when an input voltage V_{IN} is applied thereto, includes a resistance array 10 which includes resistance string 11 having N resistance elements R1 to RN connected in series from the first resistance element R1 on one outermost side thereof to the N-th resistance element RN (N is a natural number equal to or greater than 2) on the other outermost side thereof and in which the first resistance element R1 is connected to a first node in an electrical path that connects the input voltage V_{IN} and the output voltage VOUT and the N-th resistance element RN is connected to a second node in the electrical path, and a resistance change unit 20 including first to N-th bypass paths BP1 to BPN that connect intermediate nodes, which are branched from the first node and have the resistance elements R1 to RN that are adjacent to each other connected thereto, and the second node, and first to N-th switching elements S1 to SN that are connected to the first to N-th bypass paths BP1 to BPN in a one-to-one way. In this case, a total resistance value of the electrical path may be changed based on on/off operations of the first to N-th switching elements S1 to SN.

The present disclosure relates to a circuit that limits an inrush current by using a passive element during the soft start period of a power system. In a conventional boost converter that is a kind of power system, when the input voltage is applied when the level of an enable (EN) terminal is a low level, that is, at the early stage, that is, in the state in which the two power switches are turned off, an electrical path is formed between the input voltage and the output voltage. There is a problem in that a chip is damaged because the charging current of the output capacitor is unwantedly increased. The present disclosure has been contrived as a scheme for solving the problem.

However, the power system 1 to which the inrush current limiting circuit 100 according to an embodiment of the present disclosure is applied is not specially limited if a power system has only to be the power system 1 that outputs the output voltage VOUT by charging the output capacitor COUT when the input voltage V_{IN} is applied thereto. Accordingly, the power system 1 is not essentially limited to a boost converter, but may be applied to various power systems that store energy by charging the output capacitor COUT and supply power to an electronic device to an electronic load like a power loss protection (PLP) circuit.

Specifically, the inrush current limiting circuit 100 according to an embodiment of the present disclosure includes the resistance array 10 and the resistance change unit 20.

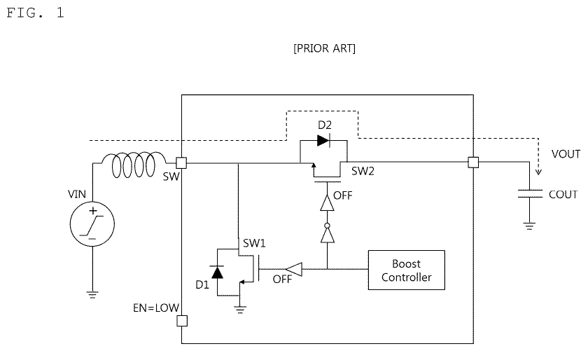

The resistance array 10 includes the resistance string 11. The resistance string 11 includes the N (N is a natural number equal to or greater than 2) resistance elements R1 to RN that are connected in series from the first resistance element R1 to the N-th resistance element RN. The resistance string 11 is connected to one area of the electrical path that connects the input voltage V_{IN} and output voltage VOUT of the power system 1, and forms a part of the electrical path. In this case, the first resistance element R1 disposed on one outermost side of the resistance string 11 is connected to the first node of the electrical path. The N-th resistance element RN disposed on the other outermost side of the resistance string 11 is connected to the second node of the electrical path. The second resistance element R2 to the M-th resistance element RM (M=N−1) are connected to an intermediate node between the first node and the second node. In this case, the intermediate node means a point at which two resistance elements that are adjacent to each other, among the N resistance elements R1 to RN, are electrically connected. In FIG. 1, the first node has been illustrated as being a node that is close to the input voltage V_{IN} on the basis of the resistance string 11, but the first node may be a node that is close to the output voltage VOUT.

The N resistance elements R1 to RN may have the same resistance value or any one or more of the N resistance elements R1 to RN may have different resistance values.

The resistance change unit 20 includes the first to N-th bypass paths BP1 to BPN and the first to N-th switching elements S1 to SN. In this case, the first to N-th bypass paths BP1 to BPN are branched from the first node and connected to the M (M=N−1) intermediate nodes and the second node. Accordingly, the first bypass path BP1 forms a path of the electrical path, which bypasses the first resistance element R1. The second bypass path BP2 forms a path of the electrical path, which bypasses the first resistance element R1 and the second resistance element R2. The N-th bypass path BPN forms a path of the electrical path, which bypasses all of the N resistance elements R1 to RN.

The first to N-th switching elements S1 to SN are connected to the first to N-th bypass paths BP1 to BPN in a one-to-one way. That is, the first switching element S1 is connected to the first bypass path BP1. The second switching element S2 is connected the second bypass path BP2. The N-th switching element SN is connected to the N-th bypass path BPN. The first to N-th switching elements S1 to SN selectively short-circuit or open the first to N-th bypass paths BP1 to BPN through their turn-on/off operations. Accordingly, a total resistance value of the electrical path is changed because the electrical path of the power system 1 is changed. For example, in the state in which all of the first to N-th switching elements S1 to SN are turned off, a total resistance value of the electrical path is the sum (=R1+R2+ . . . +RN) of resistance values of the first to N-th resistance elements R1 to RN. However, when only the first switching element S1 is turned on, a total resistance value of the electrical path is the sum (=R2+R3+ . . . +RN) of resistance values of the second to N-th resistance elements R2 to RN, and thus, the total resistance value of the electrical path is changed. The peak value of an input current that flows along the electrical path may be limited by changing the total resistance value of the electrical path as described above. In this case, the first to N-th switching elements S1 to SN may independently operate. For example, the first to N-th switching elements S1 to SN may be sequentially turned on only one by one over time in the state in which all of the first to N-th switching elements S1 to SN are initially turned off. However, the first to N-th switching elements S1 to SN should not be sequentially turned on only one by one, and two or more of the first to N-th switching elements S1 to SN may be simultaneously turned on.

The first to N-th switching elements S1 to SN may each be implemented with a transistor, but the present disclosure is not essentially limited thereto.

The inrush current limiting circuit 100 for a power system according to an embodiment of the present disclosure implements the soft start of the power system 1 by operating at a soft start time. In this case, the soft start time is the time when the output capacitor COUT of the power system 1 is initially charged by the input voltage V_{IN} to a maximum extent. For example, in the case of the boost converter, the soft start time may be the time until the output voltage VOUT is charged up to the input voltage V_{IN} when the input voltage V_{IN} is applied in a situation in which the level of the enable (EN) terminal is a low level. In this case, if the diode of a power switch is present in the electrical path that connects the input voltage V_{IN} and the output voltage VOUT, the soft start time may be considered as the time during which the output voltage VOUT is charged up to a voltage value that is obtained by subtracting the forward voltage of the diode from the input voltage V_{IN} because the output voltage VOUT cannot be charged up to the input voltage V_{IN} due to the forward voltage of the diode. The output capacitor COUT can be stably charged by changing a total resistance value of the electrical path during such a soft start time in order to limit the peak current of the power system 1 to a predetermined level or less.

Hereinafter, embodiments of the present disclosure are described more specifically by taking a process of the inrush current limiting circuit 100 for the power system according to an embodiment of the present disclosure operating by being applied to the boost converter as an example.

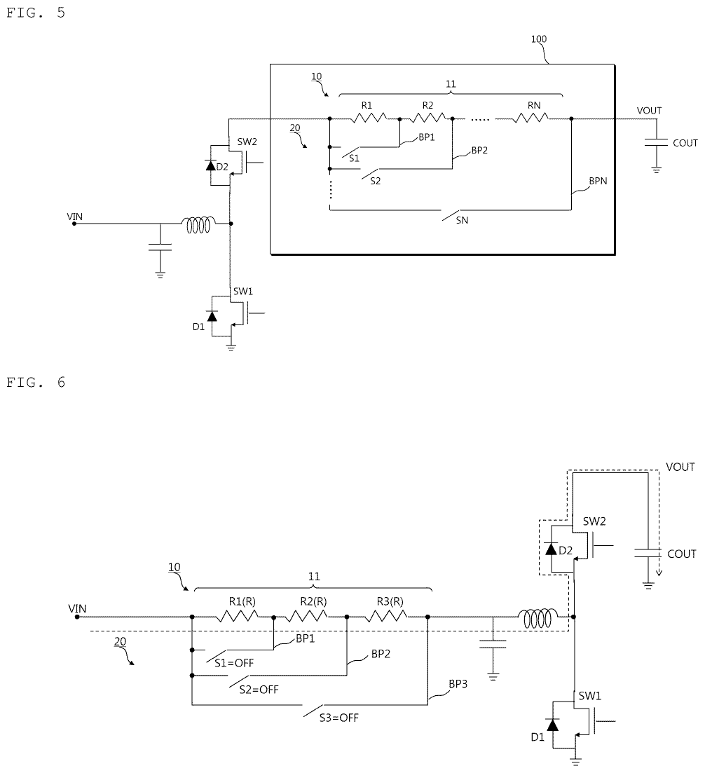

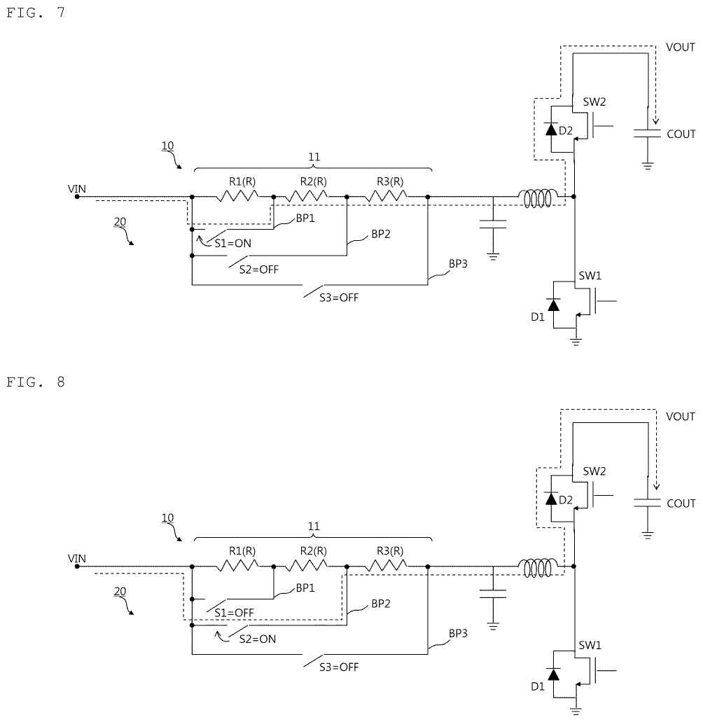

FIGS. 4 and 5 are circuit diagrams illustrating examples in which the inrush current limiting circuit for the power system according to an embodiment of the present disclosure is applied to the boost converter. FIGS. 6 to 9 are circuit diagrams describing a process of the inrush current limiting circuit for the power system according to an embodiment of the present disclosure operating by being applied to the boost converter, as illustrated in FIG. 4.

As illustrated in FIGS. 4 and 5, the inrush current limiting circuit 100 for the power system according to an embodiment of the present disclosure may be applied to the boost converter. During the soft start period of the boost converter, an electrical path that connects the input voltage V_{IN}, an inductor, a diode D2 of a second power switch SW2, and the output voltage VOUT is formed. The inrush current limiting circuit 100 for the power system according to an embodiment of the present disclosure may be applied to the electrical path on the input side or on the output side. In this case, the electrical path on the input side is an electrical path part between the input voltage V_{IN} and the inductor (refer to FIG. 4), and the electrical path on the output side is an electrical path part between the diode D2 of the second power switch SW2 and the output voltage VOUT (refer to FIG. 5), but the present disclosure is not essentially limited thereto. The inrush current limiting circuit 100 for the power system according to an embodiment of the present disclosure may be applied to any area of the electrical path that connects the input voltage V_{IN} and output voltage VOUT of the boost converter during the soft start period.

FIGS. 6 to 9 illustrate operating processes of the inrush current limiting circuit 100 when the inrush current limiting circuit 100 for the power system according to an embodiment of the present disclosure is applied to the input side of the boost converter as illustrated in FIG. 4. In this case, it is assumed that the resistance string 11 of the inrush current limiting circuit 100 for the power system according to an embodiment of the present disclosure includes three resistance elements R1 to R3, the resistance elements R1 to R3 have the same resistance value R, and the three switching elements S1 to S3 are sequentially turned on one by one.

FIG. 6 illustrates an operation of the inrush current limiting circuit 100 in the state in which all of the switching elements S1 to S3 are turned off (OFF). In this case, an input current flows along an electrical path while passing through the three resistance elements R1 to R3, and a total resistance value of the electrical path is 3R.

FIG. 7 illustrates an operation of the inrush current limiting circuit 100 in the state in which the first switching element S1 is turned on (ON). In this case, a total resistance value of an electrical path is 2R because the electrical path that bypasses the first resistance element RI is formed.

FIG. 8 illustrates an operation of the inrush current limiting circuit 100 in the state in which the first switching element S1 in the on state in FIG. 7 is turned off (OFF) and the second switching element S2 is turned on (ON). In this case, an electrical path that bypasses the first resistance element R1 and the second resistance element R2 is formed. Accordingly, a total resistance value of the electrical path is R.

FIG. 9 illustrates an operation of the inrush current limiting circuit 100 in the state in which the second switching element S2 in the on state in FIG. 8 is turned off (OFF) and the third switching element S3 is turned on (ON). In this case, as an electrical path that bypasses all of the resistance elements R1 to R3 is formed, a total resistance value of the electrical path is “0”, and the input voltage V_{IN} and the output voltage VOUT are short-circuited. In this case, the soft start of the power system may be completed.

In the above conditions, the peak value of the input current may be calculated according to Equation 1.

$${I}_{Peak} = \frac{{V}_{IN} ( 1 - \frac{i}{N} )}{( N - i ) R} \qquad ( 1 )$$

In Equation 1, I_{Peak} is the peak value of the input current, V_{IN} is a voltage value of the input voltage V_{IN}, R is a resistance value of each of the resistance elements R1 to RN of the resistance string 11, N is the number of resistance elements R1 to RN of the resistance string 11, and i is the number of resistance elements R1 to RN of the resistance string 11, which has been bypassed.

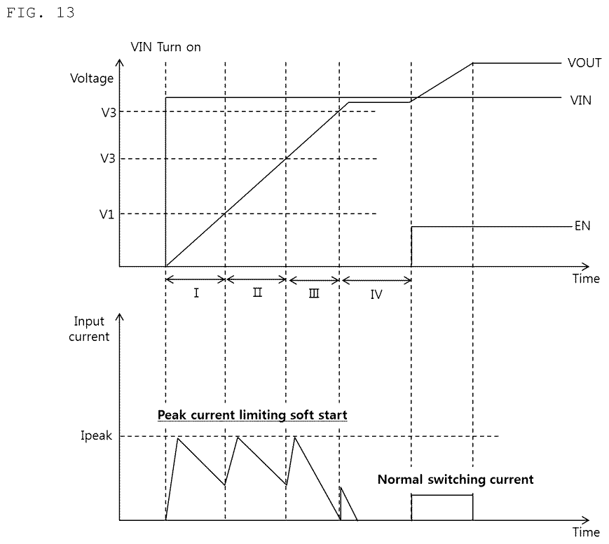

From Equation 1, it may be seen that the peak value of the input current is identically limited to “V_{IN}/(3R)” during the soft start period according to FIGS. 6 to 8 (refer to FIG. 13).

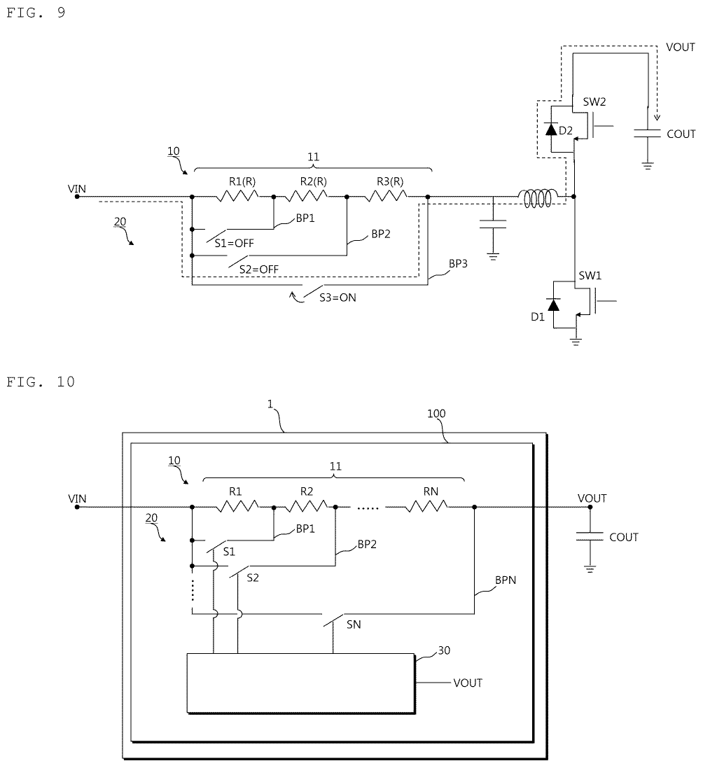

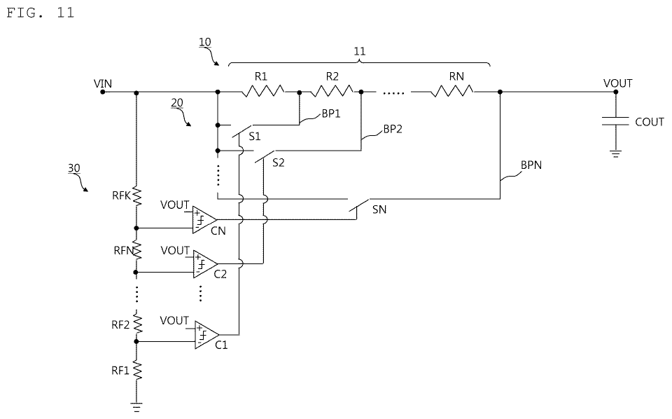

FIG. 10 is a circuit diagram illustrating an inrush current limiting circuit for a power system according to another embodiment of the present disclosure. FIG. 11 is a circuit diagram illustrating an embodiment of a switching control unit illustrated in FIG. 10.

As illustrated in FIG. 10, the inrush current limiting circuit 100 for the power system according to another embodiment of the present disclosure includes the resistance array 10 and the resistance change unit 20, and may further include a switching control unit 30.

The switching control unit 30 detects the voltage value of the output voltage VOUT, and controls the turn-on/off operations of the first to N-th switching elements S1 to SN by outputting a control signal based on the detected voltage value of the output voltage VOUT. After detecting the voltage value of the output voltage VOUT, the switching control unit 30 may compare the voltage value of the output voltage VOUT and each of preset reference voltages V1 to VN, and may control the turn-on/off operations of the first to N-th switching elements S1 to SN so that a total resistance value of the electrical path after the comparison becomes smaller than the total resistance value of the electrical path before the comparison when the output voltage VOUT is higher than each of the reference voltages V1 to VN. The switching control unit 30 may be directly implemented with hardware, may be implemented with a software module that is executed by hardware, or may be implemented with a combination of hardware and a software module. The software module may always be resident in random access memory (RAM), read only memory (ROM), erasable programmable ROM (EPROM), electrically erasable programmable ROM (EEPROM), flash memory, a hard disk, a detachable type disk, CD-ROM, or a computer-readable recording medium having an arbitrary form, which is well known in the technical field to which the present disclosure belongs.

For example, as illustrated in FIG. 11, the switching control unit 30 may include K (K is N+1 and N is a natural number equal to or greater than 2) reference resistance elements RF1 to RFN and N comparators C1 to CN.

The K reference resistance elements RF1 to REN are connected in series between the ground and a third node in the electrical path that connects the input voltage V_{IN} and the output voltage VOUT. The N reference resistance elements RF1 to RFN may have the same resistance value or any one or more of the N reference resistance elements RF1 to RFN may have different resistance values. In this case, a node at which two reference resistance elements that are adjacent to each other, among the K reference resistance elements RF1 to RFN, are connected is defined as a reference node. Accordingly, the K reference resistance elements RF1 to RFN are connected in series through N reference nodes. The third node may be formed on the electrical path on the input side, and may be the same node as the first node.

Each of the N comparators C1 to CN is a comparator circuit that is implemented with an OP Amp. Any one OP Amp has two input stages. One of the two input stages is connected to any one of the N reference nodes, and the voltage of the reference node is input thereto. The output stage of the any one OP Amp is matched with any one of the first to N-th switching elements S1 to SN. As a result, the N comparators C1 to CN are matched with the N reference nodes and the N switching element S1 to SN in a one-to-one way.

The voltage value of the output voltage VOUT is input to the other of the two input stages of the OP Amp. Accordingly, each of the N comparators Cl to CN may compare the voltage of the reference node, which is applied thereto, that is, each of the reference voltages VI to VN, and the voltage value of the output voltage VOUT, and may output a control signal so that a turn-on operation is performed on one of the first to N-th switching elements S1 to SN that are matched, when the voltage value of the output voltage VOUT is higher than each of the reference voltages V1 to VN.

In this case, an interval in which the first to N-th switching elements S1 to SN operate can be easily set because the reference voltages VI to VN are determined based on the resistance values of the K reference resistance elements RF1 to RFN.

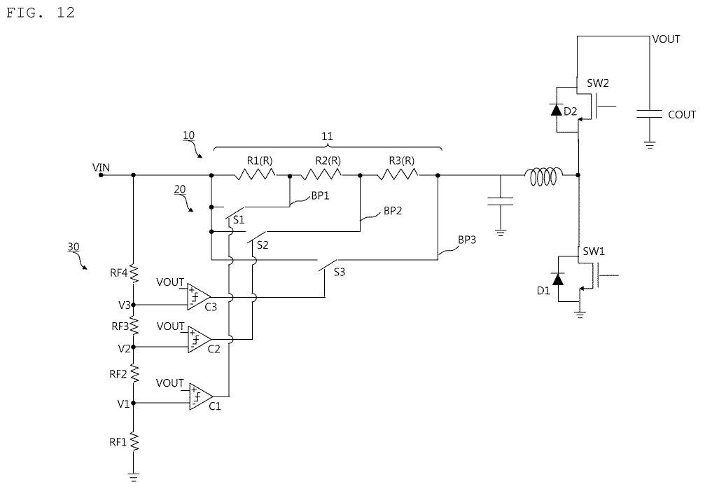

Hereinafter, an operation of the inrush current limiting circuit for the power system according to another embodiment of the present disclosure is described more specifically with reference to FIGS. 12 and 13.

FIG. 12 is a circuit diagram describing a process of the inrush current limiting circuit 100 for the power system according to another embodiment of the present disclosure operating by being applied to the boost converter. FIG. 13 is a graph illustrating a change in the output voltage and input current of the boost converter during each period in which the switching elements illustrated in FIG. 12 sequentially operate.

FIG. 12 illustrates a circuit in which four reference resistance elements RF1 to RF4 and three comparators C1 to CN are added to the switching control unit 30 in the inrush current limiting circuit 100 for the power system illustrated in FIGS. 6 to 9.

In this case, first to third reference voltages V1 to V3 may be represented as in Equation 2.

$$V 1 = \frac{RF 1 \times VIN}{RF 1 + RF 2 + RF 3 + RF 4} \\ V 2 = \frac{( RF 1 + RF 2 ) \times VIN}{RF 1 + RF 2 + RF 3 + RF 4} \\ V 3 = \frac{( RF 1 + RF 2 + RF 3 ) \times VIN}{RF 1 + RF 2 + RF 3 + RF 4} \qquad ( 2 )$$

According to Equation 2, it may be seen that the voltage values of the first to third reference voltages V1 to V3 are greater from the first reference voltage V1 to the third reference voltage V3 and are determined based on the resistance values of the four reference resistance elements RF1 to RF4.

The first comparator C1 to which the first reference voltage V1 having the smallest voltage value is input controls a switching operation of the first switching element S1. The third comparator C3 to which the third reference voltage V3 having the greatest voltage value is input controls the third switching element S3. The second comparator C2 to which the second reference voltage V2 having an intermediate voltage value is input controls the second switching element S2.

At the beginning, in the state in which all of the first to third switching elements S1 to S3 are turned off, the output voltage VOUT is generated as an input current flows along an electrical path (a dotted arrow) as indicated in FIG. 6. The voltage value of the output voltage VOUT gradually rises (i.e., an interval I in FIG. 13). In this case, the output voltage VOUT is input to the first to third comparators C1 to CN.

When the voltage value of the output voltage VOUT becomes higher than the first reference voltage V1, the first comparator C1 turns on the first switching element S1 (i.e., an interval II in FIG. 13). Accordingly, an input current flows along an electrical path (a dotted arrow) as indicated in FIG. 7.

When the voltage value of the output voltage VOUT becomes higher than the second reference voltage V2, the first comparator C1 turns off the first switching element S1, and the second comparator C2 turns on the second switching element S2 (i.e., an interval III in FIG. 13). Accordingly, an electrical path (a dotted arrow) is formed as indicated in FIG. 8.

When the voltage value of the output voltage VOUT becomes higher than the third reference voltage V3, the second comparator C2 turns off the second switching element S2, and the third comparator C3 turns on the third switching element S3 (i.e., an interval IV in FIG. 13). In this case, as an electrical path (a dotted arrow) is formed as indicated in FIG. 9, the soft start of the power system is completed.

The peak value of the input current illustrated in FIG. 13 is identically “V_{IN}/(3R)” in all of the intervals I to III according to Equation 1.

As a result, according to an embodiment of the present disclosure, the peak value of the input current can be easily adjusted by changing a total resistance value of an electrical path. The possibility of an abnormal operation is low because the peak value of the input current is set by the input voltage V_{IN} and the resistance elements R1 to RN of the resistance string 11. Furthermore, a time zone interval (i.e., the intervals I to IV in FIG. 13) in which the peak value of the input current is adjusted and the soft start of the power system is completed can be easily adjusted by controlling the resistance values of the reference resistance element RF1 to RFN. The waveform of the input current can also be easily adjusted because the number of resistance elements R1 to RN of the resistance string 11 and the number of switching element S1 to SN can be adjusted. The waveform of the input current becomes flat as the number of resistance elements R1 to RN of the resistance string 11 and the number of switching element S1 to SN are increased. Moreover, a soft start time can be predicted based on a relation between the peak value of the input current and the output voltage VOUT, and power consumption can be reduced by minimizing the size of the switching elements S1 to SN.

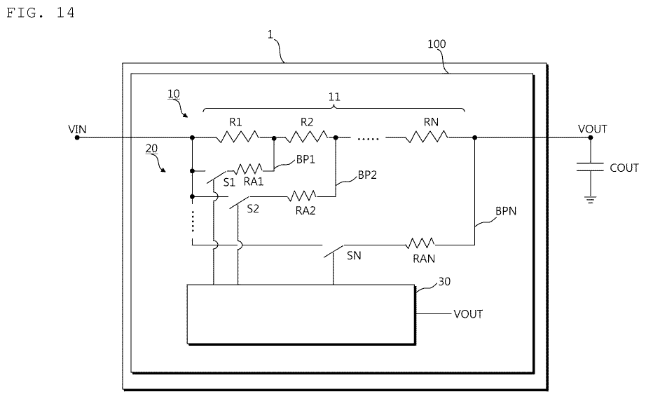

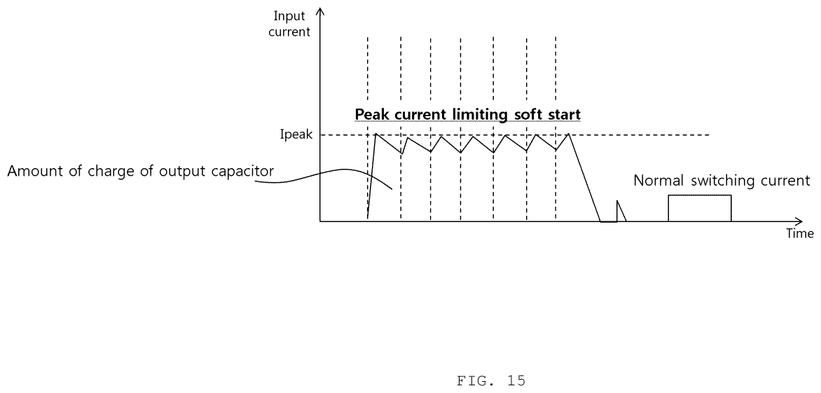

FIG. 14 is a circuit diagram illustrating an inrush current limiting circuit for a power system according to still another embodiment of the present disclosure. FIG. 15 is a graph illustrating a change in the input current of a boost converter during each period in which the switching element illustrated in FIG. 14 operates.

As illustrated in FIG. 14, the inrush current limiting circuit 100 for the power system according to still another embodiment of the present disclosure includes the resistance array 10 including the resistance string 11 and the resistance change unit 20 in the inrush current limiting circuit 100 for the power system according to the embodiment of the present disclosure (refer to FIG. 3). In this case, the resistance array 10 may further include N (N is a natural number equal to or greater than 2) affiliated resistance elements RA1 to RAN. Furthermore, the inrush current limiting circuit 100 for the power system according to still another embodiment of the present disclosure may further include the switching control unit 30 of the inrush current limiting circuit 100 for the power system according to another embodiment of the present disclosure (refer to FIG. 10).

The N affiliated resistance elements RAI to RAN are first to N-th affiliated resistance elements RAI to RAN, and are connected to the first to N-th bypass paths BP1 to BPN in a one-to-one way. That is, the first affiliated resistance element RA1 is connected to the first bypass path BP1, the second affiliated resistance element RA2 is connected to the second bypass path BP2, and the N-th affiliated resistance element RAN is connected to the N-th bypass path BPN. Accordingly, when only the first switching element S1 is turned on, an electrical path through the first affiliated resistance element RAI and the second to N-th resistance elements R2 to RN by bypassing the first resistance element R1 of the resistance string 11 is formed. A total resistance value of the electrical path is the sum of resistance values of the first affiliated resistance element RAI and the second to N-th resistance elements R2 to RN. In this case, the N affiliated resistance elements RA1 to RAN may have the same resistance value or any one or more of the N affiliated resistance elements RA1 to RAN may have different resistance values. For example, the N resistance elements R1 to RN of the resistance string 11 and the N affiliated resistance elements RAI to RAN have an R2R resistance structure, and resistance values thereof may be set. In this case, among the N resistance elements R1 to RN, the resistance value of the first resistance element R1 may be 2R, all of the resistance values of the second to N-th resistance elements R2 to RN may be R, and all of the resistance values of the N affiliated resistance elements RA1 to RAN may be 2R.

The switching control unit 30 may control the resistance change unit 20 so that only any one of the first to N-th switching elements S1 to SN is turned on or two or more or all of the first to N-th switching elements S1 to SN are turned on.

When the switching control unit 30 turns on any one or two or more of the first to N-th switching elements S1 to SN, a total resistance value of an electrical path can be changed relatively more finely and the waveform of the peak value of an input current can become relatively flat (refer to FIG. 15), compared to a case in which the first to N-th switching elements S1 to SN are turned on only one by one. In this case, an area that is occupied by the waveform of the input current is the amount of charge of the output capacitor COUT. Accordingly, when the switching control unit 30 turns on any one or two or more of the first to N-th switching elements S1 to SN, the soft start time of the power system can be reduced because the amount of charge of the output capacitor COUT is relatively increased at the same time.

The detailed embodiments of the present disclosure have been described above, but merely illustrate embodiments of the present disclosure. It is evident that the present disclosure is not limited to the detailed embodiments and may be modified or improved by a person having ordinary knowledge in the art within the technical spirit of the present disclosure.

A simple modification or change of the present disclosure belongs to the scope of the present disclosure, and a detailed scope of protection of the present disclosure will become evident by the claims.

### DESCRIPTION OF REFERENCE NUMERALS

1: power system 100: inrush current limiting circuit
10: resistance array 11: resistance string
R1 to RN: first to N-th resistance elements
RA1 to RAN: first to N-th affiliated resistance elements
20: resistance change unit
BP1 to BPN: first to N-th bypass paths
S1 to SN: first to N-th switching elements
30: switching control unit
RF1 to RFN: first to N-th reference resistance elements
C1 to CN: first to N-th comparators

What is claimed is:

1. An inrush current limiting circuit for a power system, which implements a soft start of the power system that outputs an output voltage by charging an output capacitor when an input voltage is applied, the inrush current limiting circuit comprising:
a resistance array comprising a resistance string comprising N resistance elements that are connected in series from a first resistance element on one outermost side thereof an N-th resistance element (N is a natural number equal to or greater than 2) on the other outermost side thereof, wherein the first resistance element is connected to a first node in an electrical path that connects the input voltage and the output voltage, and the N-th resistance element is connected to a second node in the electrical path; and
a resistance change unit comprising first to N-th bypass paths that connect intermediate nodes that are branched from the first node and to which resistance elements that are adjacent to each other, among the N resistance elements, are connected and the second node and first to N-th switching elements that are connected to the first to N-th bypass paths in a one-to-one way,
wherein a total resistance value of the electrical path is changed by on/off operations of the first to N-th switching elements.

2. The inrush current limiting circuit of claim 1, wherein the power system comprises a boost converter circuit or a power loss protection (PLP) circuit.

3. The inrush current limiting circuit of claim 1, wherein the N resistance elements have an identical resistance value or any one or more of the N resistance elements have different resistance values.

4. The inrush current limiting circuit of claim 1, wherein the resistance array further comprises N affiliated resistance elements that are connected to the first to N-th bypass paths in a one-to-one way.

5. The inrush current limiting circuit of claim 1, further comprising a switching control unit configured to detect a voltage value of the output voltage and to control the on/off operations of the first to N-th switching elements based on the detected voltage value of the output voltage.

6. The inrush current limiting circuit of claim 5, wherein the switching control unit
compares a preset reference voltage and the voltage value of the output voltage, and
controls the on/off operations of the first to N-th switching elements so that a total resistance value of the electrical path after the comparison becomes smaller than a total resistance value of the electrical path before the comparison when the voltage value of the output voltage is higher than the reference voltage.

7. The inrush current limiting circuit of claim 6, wherein the switching control unit comprises:
K (K is a natural number of N+1) reference resistance elements that are connected in series between a third node in the electrical path and a ground; and
N comparators connected to N reference nodes to which reference resistance elements that are adjacent to each other, among the K reference resistance elements, are connected in a one-to-one way and matched with the first to N-th switching elements in a one-to-one way,
wherein each of the N comparators compares a voltage of the reference node applied thereto, as the reference voltage, with the voltage value of the output voltage, and outputs a control signal so that the on operation of one of the first to N-th switching elements that are matched is performed when the voltage value of the output voltage is higher than the reference voltage.

8. The inrush current limiting circuit of claim 7, wherein the N reference resistance elements have an identical resistance value or any one or more of the N reference resistance elements have different resistance values.
